(19) United States
(12) Patent Application Publication
(10) Pub. No.: US 2006/0155656 A1
(43) Pub. Date: Jul. 13, 2006

(54) Internet based textbook price comparison method using entered course identification

(75) Inventors: Karl J. Kreder III, Coralville, IA (US); Rajat K. Daftuar, West Bloomfield, MI (US); Matthew J. Adams, Arlington Heights, IL (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(73) Assignee: Daftuar, Kreder, Adams Company

(21) Appl. No.: 11/256,546

(22) Filed: Oct. 21, 2005

Related U.S. Application Data
(60) Provisional application No. 60/620,885, filed on Oct. 21, 2004.

(51) Int. Cl. G06G 7/00; G06F 17/00; G06Q 30/00

(52) U.S. Cl. 705/400; 705/26

(57) ABSTRACT

A computer system and method is disclosed where the computer system allows a user to find course materials based off of the user's course schedule and obtain comparative pricing from multiple online vendors for the given course materials. A computer system and method is disclosed where the computer system provides regional and national statistics about a book to aid in the user's shopping decision. A computer system and method is disclosed that simultaneously presents pertinent information from multiple websites which allows a user to find course materials based off of the user's course schedule and obtain comparative pricing.

### CROSS-REFERENCED TO RELATED APPLICATIONS

This application claims the benefit of U.S. Provisional Application No. 60/620,885, filed Oct. 21, 2004.

### BACKGROUND OF THE INVENTION

The present invention relates to a web-based book search engine, and more particularly, but not exclusively, relating a student's schedule to required course materials and pricing information. The words ‘book’, ‘textbook’ and their respective pluralities are used interchangeably in this application.

Unlike a typical book search engine, which requires the user to know specific book information, this business method will provide a unique forum in which college students can quickly and easily obtain the textbooks for the lowest cost. There is an increasing demand for college students to save money on their scholastic expenses. Students are able to find their textbooks online at various competitively priced booksellers, but this is typically troublesome because the information needed to locate the course materials is not immediately available. Students can seek this information out either online or elsewhere, however this process can be long and cumbersome. This business is not typically or immediately available or method is an internet based solution for college students to cross reference their class schedule with their required course materials. This service will then compile listings of textbook prices and then sort them based on the most cost effective single source or the most cost effective multiple sources. Then a link(s) will be actively generated for the user, connecting them to the chosen textbook seller(s). As compensation for generating a sale, the respective bookseller pays a given commission to the book search engine provider.

This service will not only be cost effective, but quick and easy. It is different from other existing internet based textbook search engines because it only requires the college student to know their course schedule for the semester. Hence, it does not require them to know book titles, ISBN numbers, or book editions. This presents a distinct advantage for the shopper by compiling the necessary information into one single source which saves time. The search engine is centered around allowing the student to enter in any course information provided, such as the numeric course identification with or without the section or division, course title, and/or professor name. This information is then taken and cross referenced with the required course materials and a bookseller(s) is located based on a set criteria. Typically speaking, this can be the lowest price for a textbook(s) from a reputable book seller. The course information is more readily available to students, than the necessary textbook information, creating a distinct proprietary advantage over other internet based book search engines.

Currently, the textbook market for college students is one that is not competitive, thus textbook prices are inflated. Expensive books pose a problem for students because of their typically limited budget. In addition, college students usually do not have the time or resources, textbook information, to purchase their textbooks through internet based booksellers. This business method will help solve the problem of inflated textbook prices by making alternate booksellers easily accessible to students. This will be the first business method to offer an internet based book search engine, with the capability of going from class schedule, to comparative pricing of required course materials. This will give students an alternate source to purchase their books, other than the traditional college book market.

Previous methods of solving the problem of inflated textbook prices, by making internet based booksellers more accessible, have not completely eliminated the leg work involved with obtaining textbooks online. Current online search engines are sometimes used to find information about textbooks. These online search engines do not give students the capability of automatically providing pricing for textbooks in response to an input of the course schedules. These search engines typically function by having students search for their books based on book information such as title, ISBN number, author, keyword, and/or publisher, which can be searched individually or together. Once a title is located, some search engines compare the price(s) of book seller(s) and allows the user to select a retailer(s) based on this pricing information. Detailed book information known to the average college student, therefore these services have failed to eliminate the need for students to research or gather the book information.

The need for research creates a barrier, which students must overcome, to purchase their textbooks. This barrier has been addressed in some manner, by various book search engines, by linking the online counterparts of traditional college bookstores to facilitate the information gathering process. This has also been addressed by linking students to various course web pages which have the pertinent information. To date, no one has ever compiled, on a single web-site, the necessary course material information such that it can be automatically cross referenced via class schedule and/or course information. Applicants' invention allows the user to simply enter their class information for their university and then view the generated price comparison information from various online book sellers. This is advantageous over any previous business method of a book search engine because it removes the need for students to do extensive information gathering or research. This capability removes the barrier which prevents college students from finding competitive pricing from online book retailers. No book search engine has previously had this capability.

Previously, some search engines have provided links to a local bookstore's index page, from which the user could navigate to the textbook listing. These links traditionally cause a new window to open or the user to leave the book search engine website and enter the local bookstore's website. This can cause the student to be confused and/or leave the book search engine's website. The idea of linking a student to the local bookstore's website, to aid in information gathering, has been greatly improved herein. Hence another unique method has been created to assist students in finding their book information in lieu of a booklist. Specifically, frames have been utilized to simultaneously display a generic search utility and the local bookstore's website at the same time. Frames allow the content of the local bookstore's website to be simultaneously displayed with a generic book search utility. Furthermore, the frames are linked to the bookstore's textbook information directly, not the index page. This allows the student to immediately reference which books they need and quickly find them. The student is then able to obtain comparative pricing from multiple vendors. The use of frames avoids the cumbersome and confusing process of having to navigate multiple websites and/or browser windows at the same time. This helps the student find exactly what books they need for a course more quickly and easily.

Some university's booklists are very difficult to collect because there is no centralized and/or uniform system in which the book information is collected and compiled. Some of the departments of the university may compile a booklist for that department that is sent to the bookstores. The booklists that are created often times contain incorrect information and are unorganized. This is caused by the lack of expertise in both technical aptitude and knowledge of books. Furthermore, there is often poor communication between the university employees compiling the lists and the bookstores. This causes inaccuracies in the booklists either due to errors in the original list or the lack of communication of a change. While some departments require that the professors call the local bookstore(s) and place the textbook order. This creates a system with little accountability on both the people making the textbook orders and the bookstore. Moreover, the bookstore(s) will often change a book order by ordering the new edition. Sometimes this goes against the wishes of the professor or department and causes the wrong book to be ordered.

Booklists from other universities that have a centralized and/or uniform system, in which book information is collected, can also be difficult to obtain. The centralized and/or uniform system is often put in place by a single bookstore. The bookstores typically do not wish to disseminate the booklist because it will create competition. Therefore, a monopoly is created on the university's book market.

A new solution to these problems is proposed that will also facilitate list collection to meet the goals of the improved book search engine. A uniform system for collecting book information that is easy to use that is continually updated. Most importantly, the system will be provided by a third party who will openly distribute the list to any local bookstore, student organization, and university official. This is a novel method of business because no uniform system for collecting book information has ever been provided by a person(s) who solely generates revenue based on the sharing of the booklist(s). This would alleviate the problems of disorganization at some universities and would allow open market competition at others.

Students and professors both encounter difficulties when selecting a book for study/reference or for a class instruction. To solve this, professors often form textbook committees within their department or college to choose book(s) for their course(s). This can be an arduous task with professors reading and reviewing many different texts. To aid in book selection, a textbook statistic utility is proposed. This would provide professors with information on the book. Such information might include but is not limited to a list of universities which are using a book, names of professors using the book, contact information for other professors using the book, rank of universities using the book, pricing information, and/or a book review. This would help to reduce the time and effort taken by professors in selecting a book for a course. Furthermore, professors would be able to make a more educated decision. The textbook statistic utility could also aid a student in choosing a book for studying in a similar manner. These statistics could be generated from the booklists and records of previous sales of the book(s).

At the end of a semester when a student is done with a course and no longer needs the corresponding book, they may want to sell the book. Typically the student will sell the book back to the bookstore. The amount of money received by the student is typically less then half of what they originally paid. Some students choose to sell their used books online in the hopes of receiving a better price then the bookstores. Students selling their books often have to research the market and decide on an appropriate sale price.

Difficulties also arise for the student purchasing the used books. There is no way for the buyer to be sure that they are getting the correct book for a course. The difficulties of both the buyer and the seller can be lessened. The buyer can list the book they are selling by referencing it to the course in which it was used. This can then be cross referenced to the current semester's booklist to ensure the book is correct for the current course. To facilitate verification of a book the user will be asked specific information about the book they desire to sell. Only if the information provided matches the information for the book, used by the course indicated by the user, will the book be verified to be correct for the course. Once the book is verified to be correct, it will be displayed with the results from other vendors when a student performs a search for a book(s).

Furthermore, the problems the seller experiences when having to decide an appropriate selling price can be lessened. Information regarding the local and national market for the book that is being listed can be provided to the seller to aid in deciding a competitive sale price. Therefore this is a novel method of ensuring the correct book for a buyer and aids a seller in getting a competitive price for the book(s).

To reduce the amount of resources that go into compiling a booklist, a novel method is proposed. This method allows the faculty and/or students that attend a given university/college to enter the booklists for courses they are familiar with. Typically, a student who has previously taken a course, or a faculty member who has previously taught a course, knows what book(s) was used and/or the book(s) that will be used in the future. The student may or may not want to sell the book, but if they do, when they are listing the book using a method similar to the one described in paragraph a booklist can be created. The book information that is provided by all of the students listing the book(s) can be compiled into a booklist. Alternatively, if the student is a member of an online forum or community they could voluntarily enter book information for courses that they are familiar with.

Once the students have provided the book information for one reason or another the entries can be cross referenced against each other to help ensure the validity of the list. Furthermore, this can be coupled with the utility that allows professors and/or pertinent persons to enter book information, as previously described. Information from all sources can be compared for consistency and if consistent, compiled into a school's booklist. To the extent inconsistencies are noted, weighting can be given to the individual entries as to the likelihood of it being accurate. For example, professors are more likely to be accurate than students and persons who have made many earlier entries that are consistent are more likely be accurate than persons who have entered only one datapoint, and students who have entered prior inconsistent data entries are more likely to be inaccurate. The use of a calculated reputation, which can be overridden and corrected if necessary, in weighing such inputs allows for a self policing program that can be readily updated by the public.

The booklist that has been processed for accuracy and consistency can then be used in all applications previously described. The preferred embodiment of the previously described services utilizes textbook lists generated by university or bookstore persons. With the booklist in place, students can then automatically get competitive pricing from multiple sources. Finally, when the student is selecting their courses, the source(s) of the book information can be indicated so that the student can make a determination to the reliability of the information.

### SUMMARY OF THE INVENTION

This invention is a business method based on an improved online book search engine. Said search engine allows college students to enter their course information, which is automatically cross referenced to the required course materials and pertinent search information: ISBN number, title, author, edition, and publisher. The required course materials are usually comprised of one or more books, manuals, and/or guides that are used in the corresponding class. The pertinent book information is then used to automatically gather pricing information from a collection of online booksellers. A collection of online booksellers is a group of one or more online bookstore(s). The pertinent book information is then used to acquire and display the cheapest single or multiple cheapest suppliers for the required course materials. Links to the book sellers are then dynamically generated, allowing the user to immediately proceed to purchasing their books from the chosen vendor.

Accordingly, several advantages of the invention, business method, are to provide an improved online book search engine. Principally this method allows students to quickly and easily locate their required course materials from the cheapest book seller. Whereas, students are able to determine their course materials and find the cheapest source for their books with only knowing their class schedule. This provides a more user friendly and streamlined process which students can utilize to purchase their books.

In addition there is another invention described herein. This invention is a business method in which frames are utilized to display information simultaneously from multiple sources to aid students in finding their textbooks. More specifically, the local bookstore's website is displayed in part or in its entirety to the student on the same page as a book search utility. This helps students expedite the process of finding out what books are used for the course, and allows the student to obtain comparative pricing.

In addition there is another invention described herein. This invention is a business method in which a uniform utility is provided for the collection, compilation and distribution of booklists. Revenue is solely generated by freely distributing the list and/or using the compiled booklists to aid in the business method outlined herein.

In addition there is another invention described herein. This invention is business method which helps students and/or professors decide which book they would like to buy. This is done by providing statistics to the students and/or professors that are derived from the booklists previously discussed.

In addition there is another invention described herein. This invention is a business method which enables students to more effectively sell and/or buy used books. This is done by cross referencing information provided by the seller to the booklist to verify it is the appropriate book for the given course for the buyer. Furthermore, the seller is provided historic pricing information that enables them to sell the book at a market appropriate price.

In addition there is a further embodiment of the book list utility described herein. This invention allows the book list creation utility to be used by students when the booklist is not able to be generated by other means. This decreases the resources needed to create a schools booklist, but this is usually not preferred because of the potential inaccuracies of the list.

### BRIEF DESCRIPTION OF THE DRAWINGS

FIG. 1a and FIG. 1b are flowcharts which depict the sequence of steps to utilize the previous book search engines.

FIG. 2 is a flowchart which depicts sequence of steps to utilize improved book search engine.

FIG. 3 is a flowchart which describes one possible solution of servicing the user, defined by the process in FIG. 2. Note: This is not an absolute implementation to the proprietary process outlined in FIG. 2. It is just one possible implementation included for clarity.

FIG. 4 through FIG. 30 are representations of internet based webpages which are displayed in internet browser(s).

FIG. 4, FIG. 5, FIG. 6 and FIG. 7 are depictions of the process a user follows to find and select course materials. FIG. 4 allows the user to select their institution. FIG. 5 allows the user to select a desired semester, department, course and division. This webpage also gives the user the option of searching for non course specific books. FIG. 6 displays the results of either the user's non course specific search and/or the user requested course specific materials. Moreover, FIG. 6 enables the user to select the desired course materials from the results and add them to the shopping list. FIG. 7 displays the users shopping list and allows them to add/select more course materials.

FIG. 8, FIG. 9 and FIG. 10 display the price of the selected books of multiple vendors. FIG. 8 displays the single cheapest source for the specified course materials. FIG. 9 displays cheapest combination of multiple sources for the specified course materials. FIG. 10 displays pricing information from all vendors for the specified course materials.

FIG. 11 and FIG. 12 are depictions of the process a user follows if the list of course materials for a given institution is unavailable. FIG. 11 displays the local/college bookstore's website to the user in addition to a non course specific search utility FIG. 12 displays the users shopping list and allows them to add/select more course materials.

FIG. 13 and FIG. 14 comprise the utility that allows the collection of course material information from the course's professor(s). FIG. 13 allows the professor(s) to enter pertinent course and corresponding course material information. FIG. 14 displays previously entered course materials and allows the professor to edit the list.

FIG. 15 is a depiction of a utility that aids the professor in the distribution of the booklist.

FIG. 16, FIG. 17, and FIG. 18 comprise a textbook statistic utility which aids primarily the professor when choosing a book for a course. It can also aid a user in choosing a “good” book for a given subject.

FIG. 19 is a simulated webpage that allows the user to select a book they desire to sell, by selecting the course in which it is currently used.

FIG. 20 is a simulated webpage that provides the user with statistics about a book(s) they have chosen to sell.

FIG. 21, comprised of FIGS. 21a-21d, is a flowchart of one possible implementation of an improved search engine which utilizes novel methods.

FIG. 22 is a network diagram of the system on which the previously described improved search engine operates.

### DETAILED DESCRIPTION OF SELECTED EMBODIMENTS

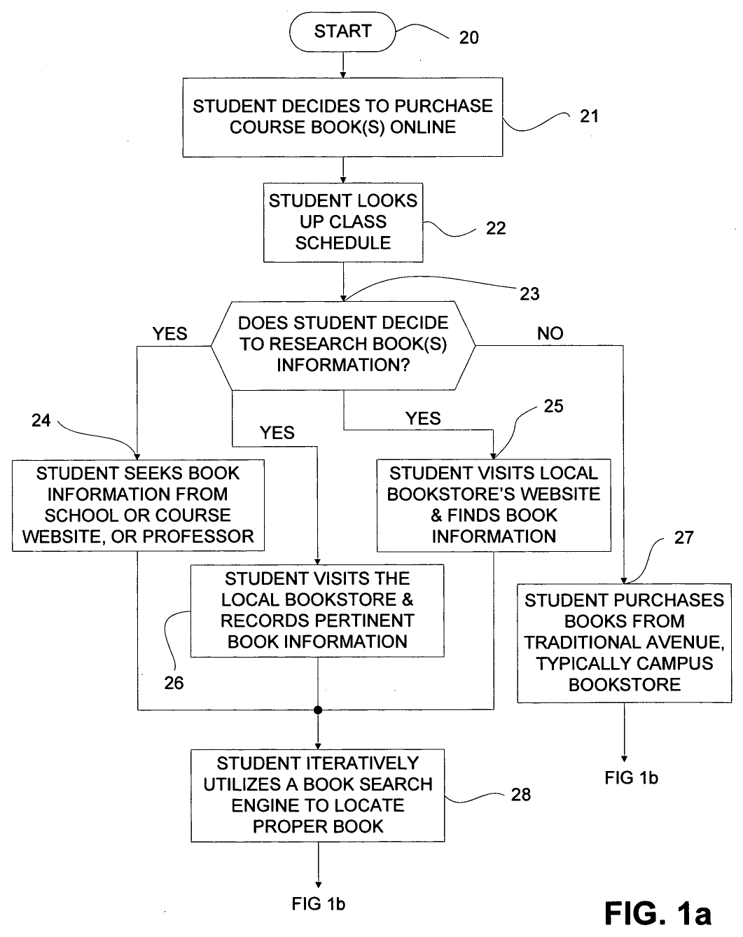

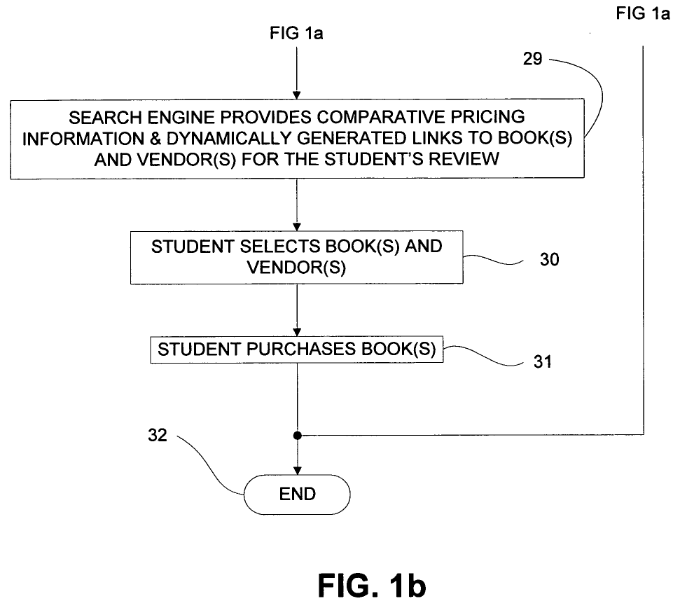

FIG. 1a and FIG. 1b are flowcharts that depict the general process followed by the old online book search engine methodology. Once the student decides to purchase their textbooks online 21, they must determine their class schedule 22. If the student chooses not to purchase book(s) online they will most likely acquire books through traditional means 27. With the old textbook search engine process, the college student would then have to determine how they would like to determine the required course materials 23. There are three principle routes that the student could take, though these are not exclusive or all encompassing. They could search course or school websites for the required course materials 24, make a trip to the local bookseller 26 where the required course materials as well as the pertinent book information, particularly the ISBN, can be found. Finally, the student could reference the local book-stores website 25 where partial book information such as title, author, and edition could be found. If only partial information is obtained from any source, the student must iteratively search 28 for the missing information. Once the required book information is obtained, the student can utilize a traditional textbook 29 search engine to find price comparison data across multiple online book sellers. The student can then select which vendor(s) they wish to use 30 and purchase their book(s) 31.

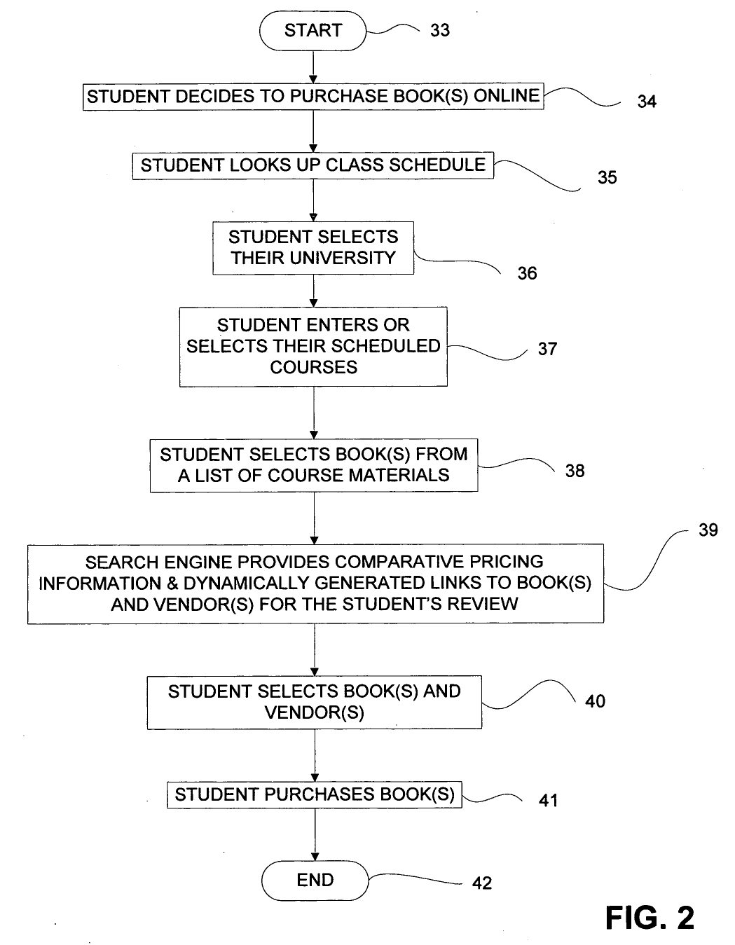

FIG. 2 is a flowchart that depicts the general process for the new online book search engine methodology. Again, when the student decides to purchase their books online 34, they look up their course schedule 35. The student indicates which university they attend 36. They then input their course schedule into the search engine 37. The search engine automatically references an internal database which provides the list of book(s) for the respective course(s). The student selects the books they desire to find pricing on from the list of book(s) 38. The pertinent book information that the student has selected is used to provide comparative pricing information across multiple vendors 39. The student can then review the pricing information and select which books they want to buy from which vendors 40. The student then clicks on dynamically generated links, which direct them to the specific book on a vendor's website, and purchases the book 41.

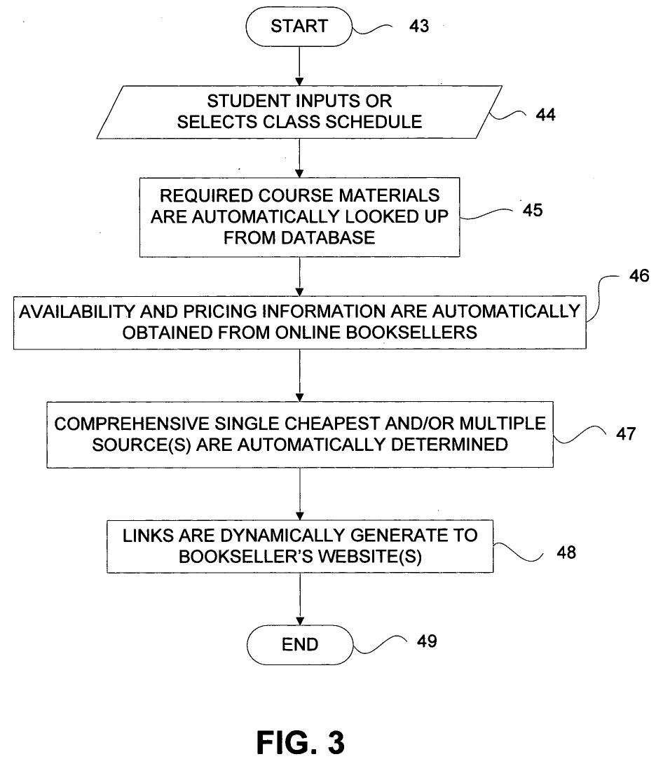

FIG. 3 is a flowchart depicting a possible method of fulfilling the service as outlined in FIG. 2. Note: This is not an absolute implementation to the proprietary process outlined in FIG. 2. It is just one possible implementation included for clarity. After the student has input their course information 44, the list of book(s) for the respective course(s) are looked up in a database 45. This data is then used to obtain pricing information from multiple book sellers 46. The comprehensive cheapest single vendor and/or multiple vendors are determined, sorted and displayed to the user 47. In addition, pricing and availability of the book(s) for all vendors is returned to the user. Furthermore, a hyperlink is then dynamically generated which connects the user to the respective book on the respective vendor's page 48.

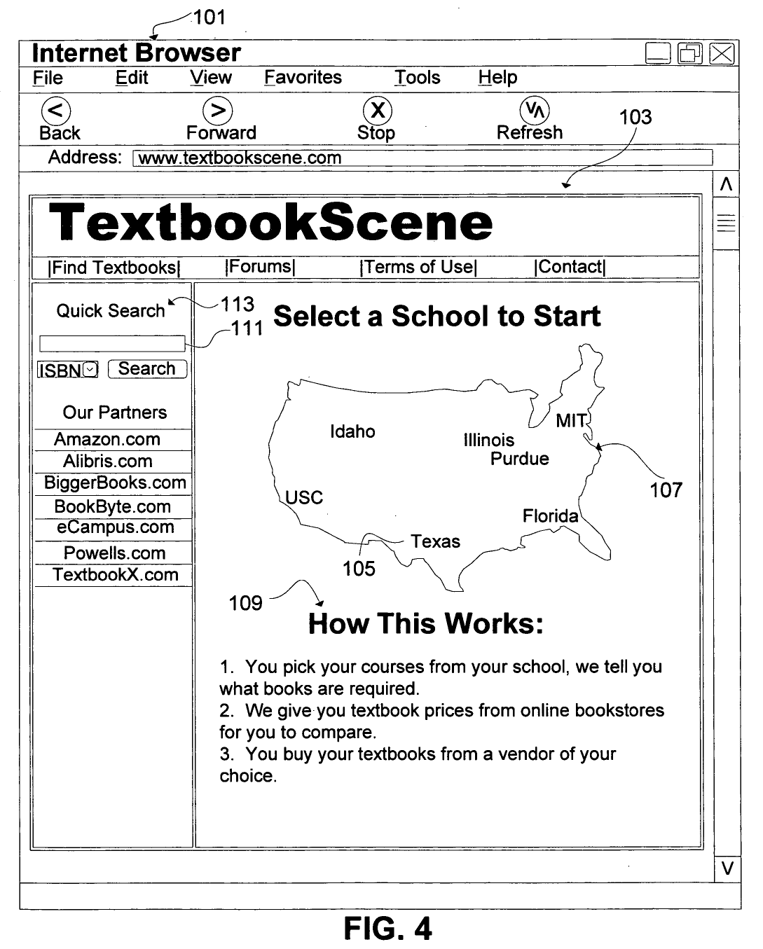

FIG. 4 is the index or homepage of the website. This page and all subsequent webpages are displayed in an internet browser 101. Webpage 103 allows the user to select their academic institution, typically a college or university. The user can select their respective institution 105 from a map 107, or by means of an alternate method familiar to all those skilled in the art of web design. Examples are not limited to but include a pull down menu(s), a list(s), or an interactive application(s) such as a Java applet. Also provided to the user is a brief description 109 of the process used. The user also has the ability to find non institution specific materials. The user enters their search query 111 and then executes the search using the search utility 113.

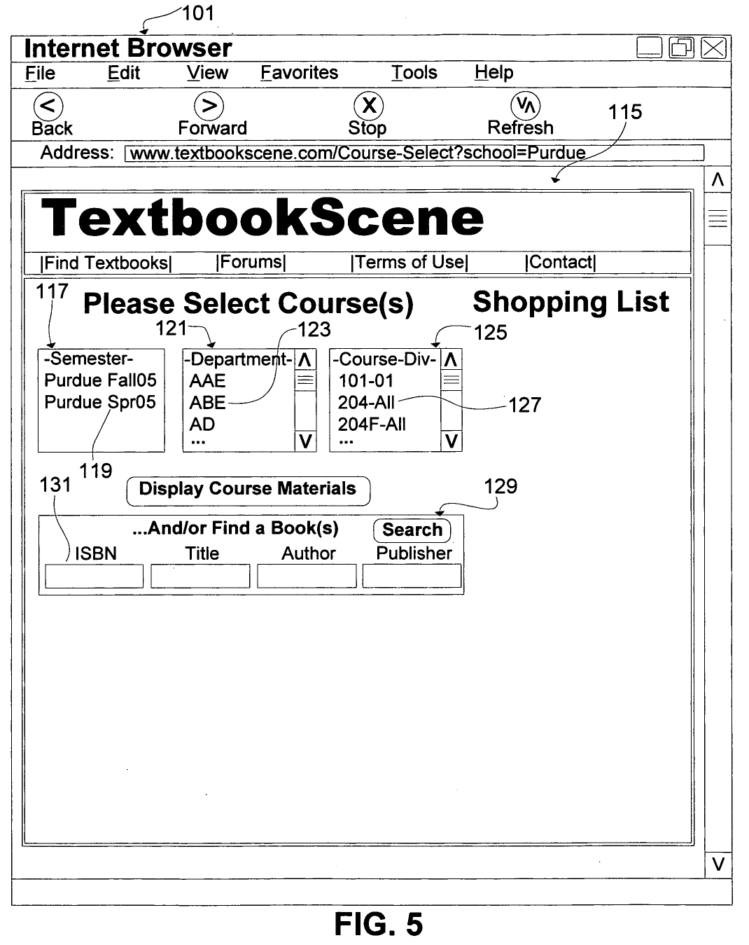

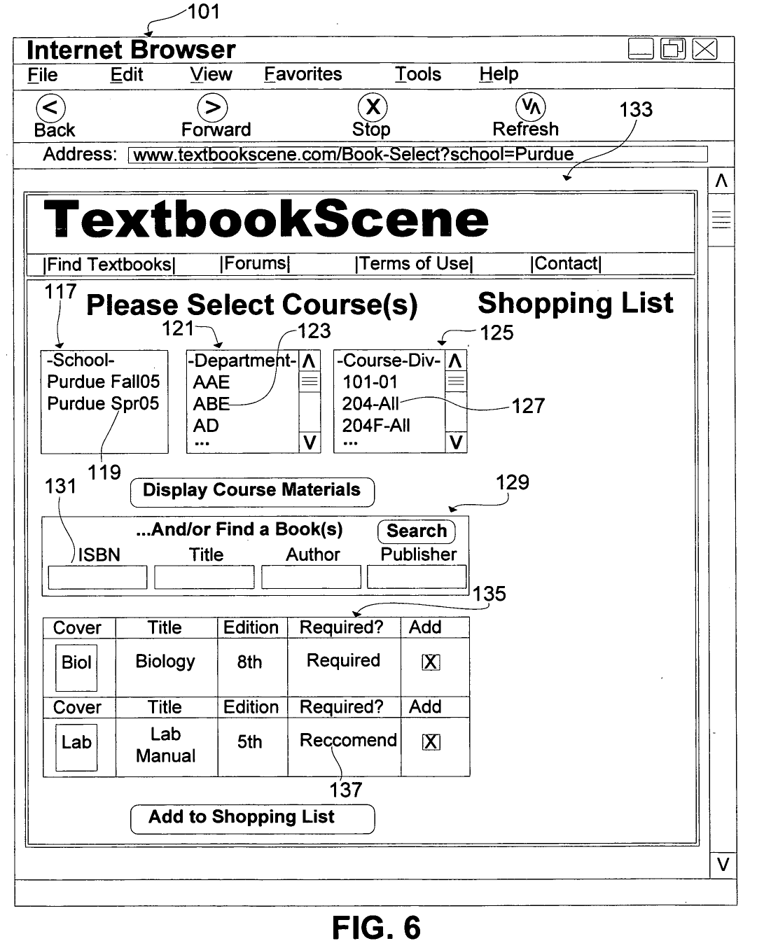

FIG. 5 shows webpage 115 which allows the user to find their course materials. The user can either select the course(s) they are taking or search for their course materials. In the semester field 117 the user selects the desired semester 119. The departmental information corresponding to the selected semester is then displayed in the department field 121. The user selects a department 123. Then the course and division and/or section information corresponding to the department is displayed in the course field 125. If the user is not able to find their course or already knows their course materials they can find them using the search utility 129. The user enters pertinent course material information, such as ISBN, title. author, publisher, edition and/or publication date, into a query field 131. The information provided by the user is used to display pertinent course materials on webpage 133 in FIG. 6.

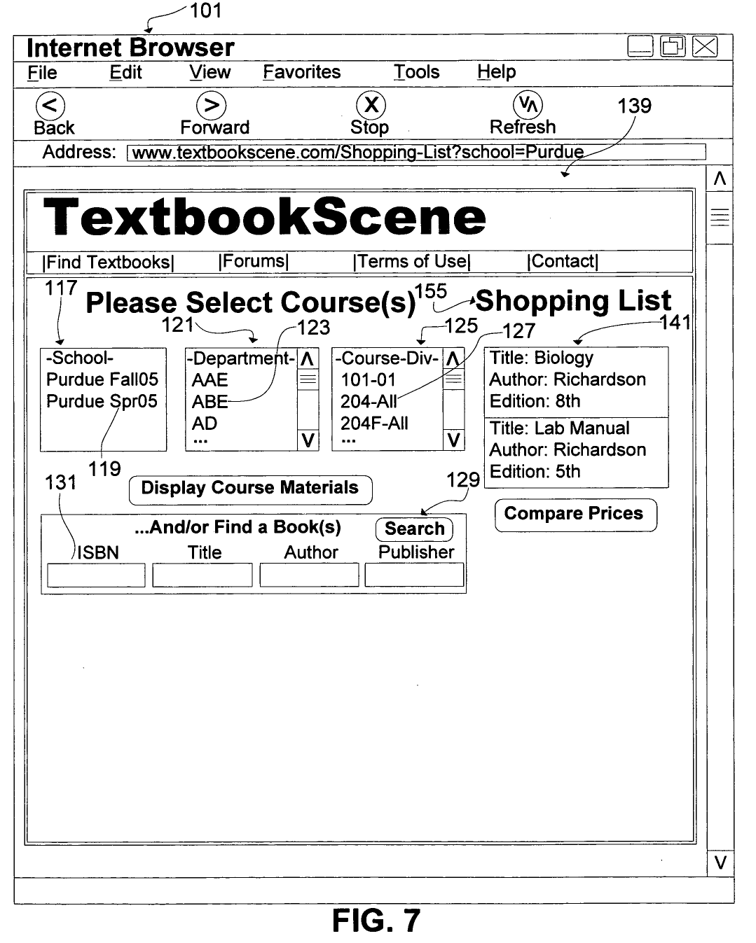

FIG. 6 shows webpage 133 which displays the course materials that correspond to the information previously entered by the user on webpage 115 in FIG. 5. The pertinent course materials are displayed in the results chart 135. The result chart 135 includes detailed course material information. Including but not limited to the title, author, publisher, edition, publication date, if the item is required or recommended 137 and/or a picture of the item. The user is able to add any number of items from the results chart 135 to the shopping list 141 in FIG. 7.

FIG. 7 shows webpage 139 which displays the shopping list 141 with the previously added book(s). The user is able to find and add new books to the shopping list using the process described above.

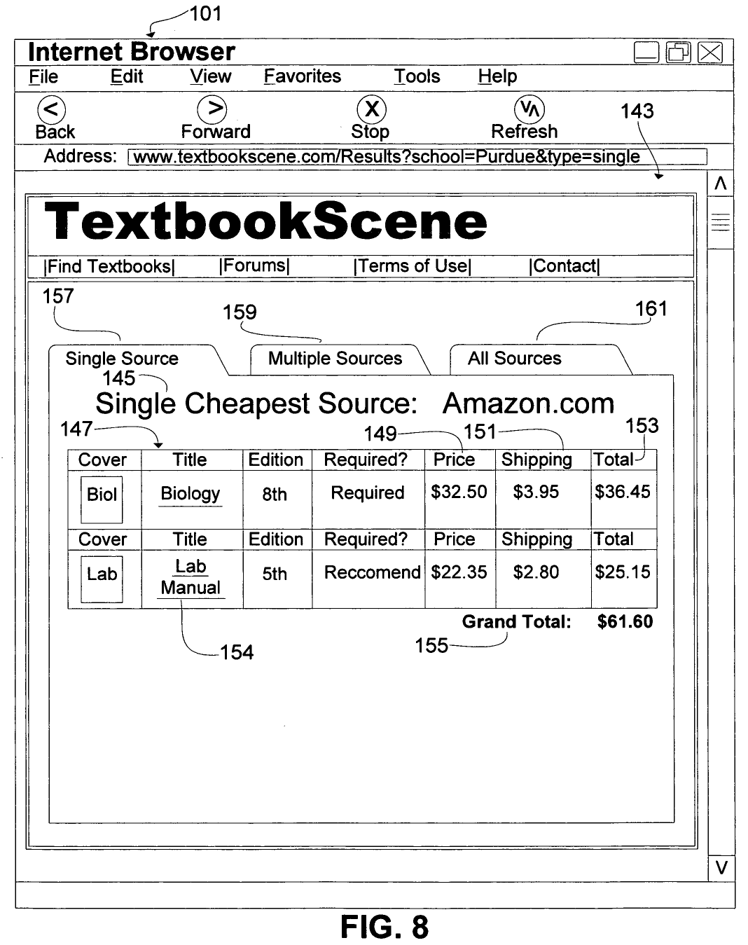

FIG. 8 is a simulated screen of webpage 143 which displays the single cheapest vendor 145 for the selected materials. The pricing chart 147 displays pricing and availability of each item. The information displayed includes but is not limited to the title, author, publisher, edition, publication date, ISBN, if the item is required or recommended, a picture of the item, the price 149, shipping 151, applicable tax, discounts, and the total cost 153. Furthermore, a dynamically generated hyperlink 154 is also displayed in the pricing chart 147 which directs the user to the specific book on the corresponding vendor's website. A grand total 155 is presented to the user which is the summation of all costs associated with the purchasing the books from the given vendor. Furthermore, the user has the option of selecting how to sort the book pricing information. The user can select the single cheapest source 157, the multiple cheapest sources 159, or all pricing information for all vendors 161.

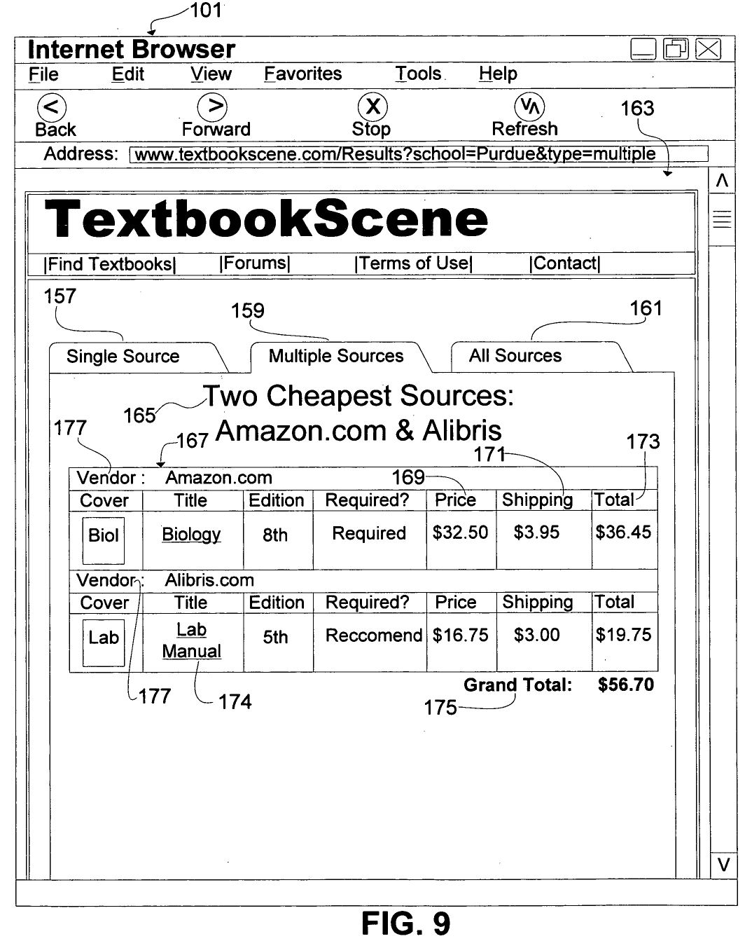

FIG. 9 is a simulated screen of webpage 163 which displays the multiple cheapest vendors 165 for the selected materials. The multiple cheapest vendors are the combinations of more then one vendor which is able to provide the selected books. These combinations are sorted in ascending order of number of venders and overall price. The pricing chart 167 displays pricing and availability of each item. This information includes but is not limited to the title, author, publisher, edition, publication date, ISBN, if the item is required or recommended, a picture of the item, the price 169, shipping 171, applicable tax, discounts, and the total cost 173. Furthermore, a dynamically generated hyperlink 174 is also displayed in the pricing chart 167 which directs the user to the specific book on the corresponding vendor's website. A grand total 175 is presented to the user which is the summation of all costs associated with the purchasing the books from the given combination of vendors 177.

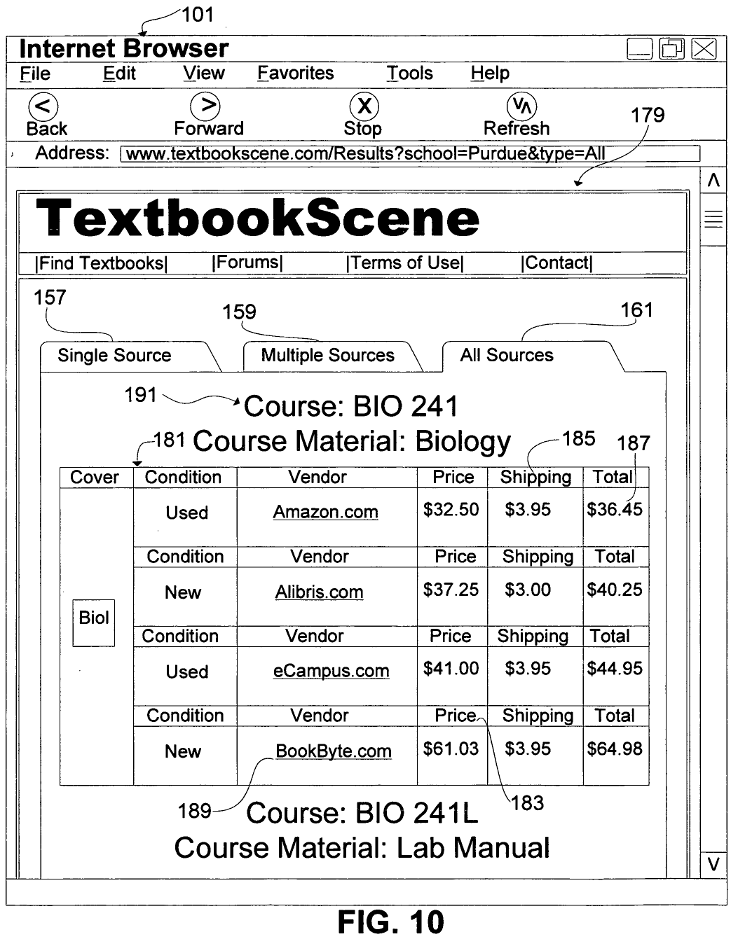

FIG. 10 is a simulated screen of webpage 179 which displays pricing information from all supported vendors with the given book. The pricing chart 181 displays pricing and availability of each item. This information includes but is not limited to the title, author, publisher, edition, publication date, ISBN, if the item is required or recommended, a picture of the item, the price 183, shipping 185, applicable tax, discounts, and the total cost 187. Furthermore, a dynamically generated hyperlink 189 is also displayed in the pricing chart 181 which directs the user to the specific book on the corresponding vendor's website. The pricing information for the books is grouped by course 191.

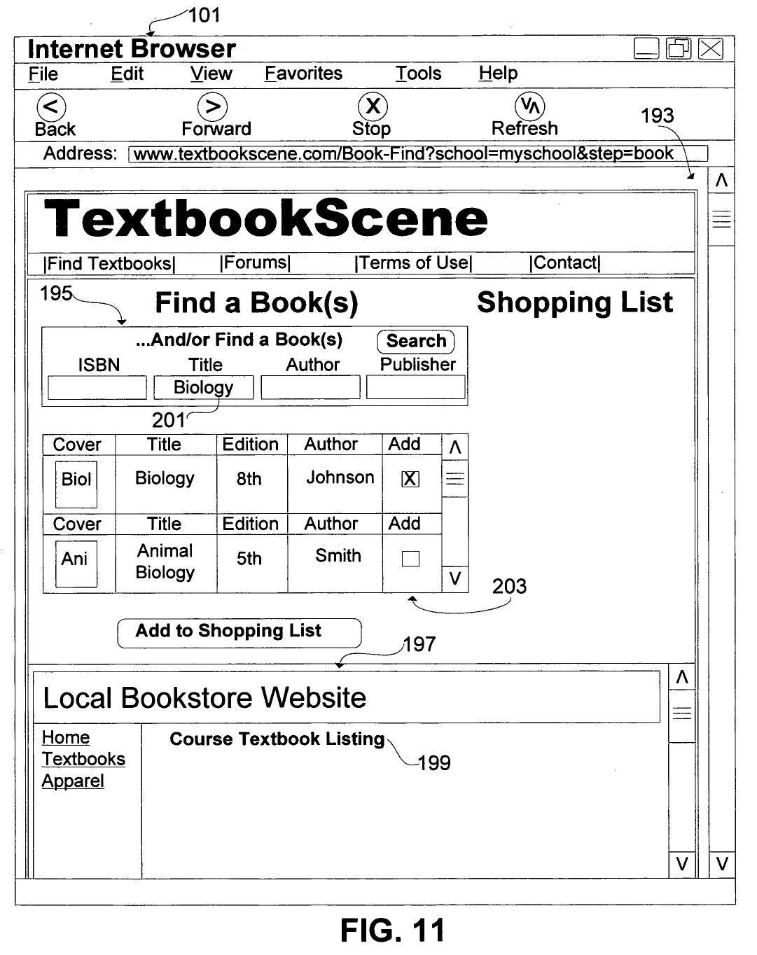

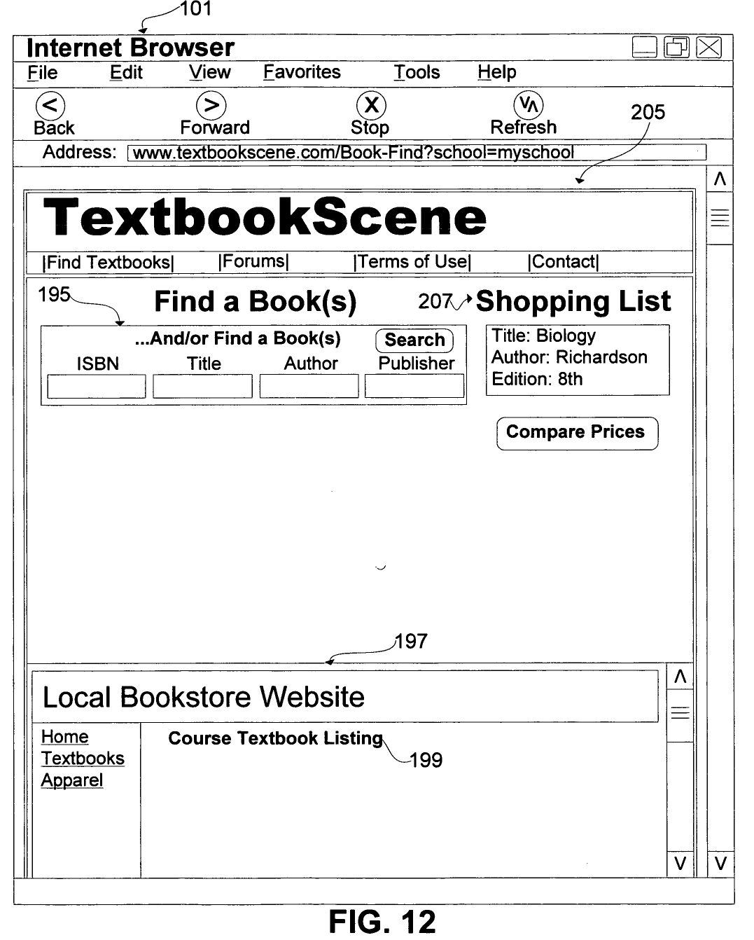

FIG. 11 is a simulated screen of webpage 193 which displays a search utility 195 and the local bookstore's website 197. The user finds their course books by referencing the course textbook listing 199 on the local bookstore's website, which is loaded at the bottom of webpage 193. The user then enters the pertinent book information into the search utility 195. This information includes but is not limited to the title 201, author, publisher, edition, publication date and/or ISBN. Pertinent results are displayed in results table 203. The user can then determine the appropriate book(s) and add it to the shopping list 123, shown in FIG. 12.

FIG. 12 is a simulated screen of webpage 205 which displays the shopping list 207 with the previously added book(s). The user is able to find and add new books to the shopping list using the process described above.

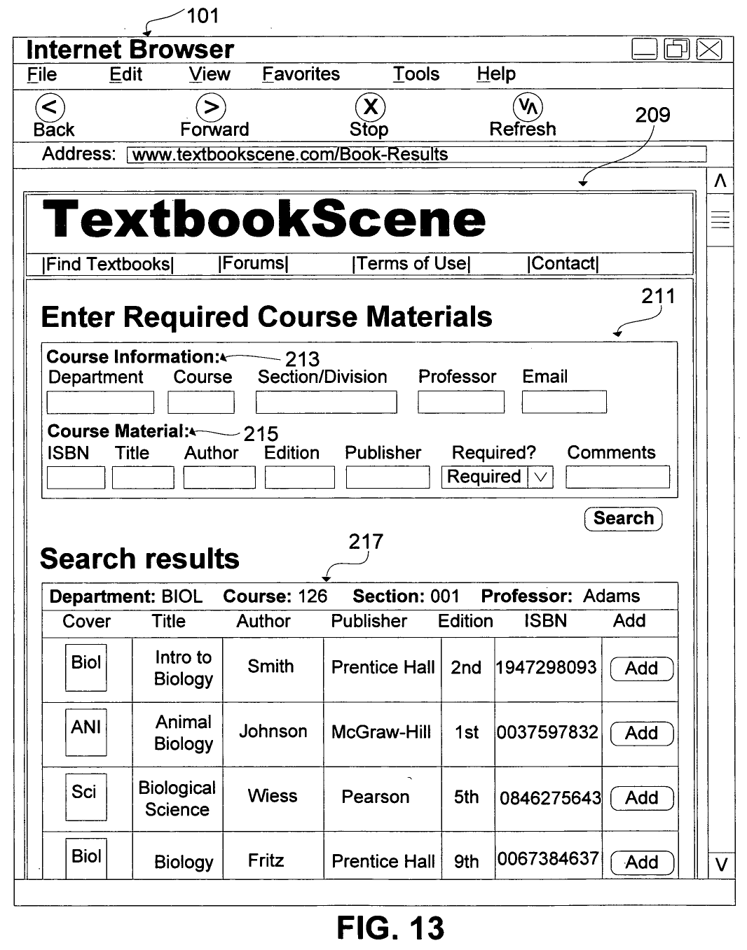

FIG. 13 is a simulated screen of webpage 209 which allows professors or the appropriate person(s) to enter course and book information. Appropriate person(s) includes but is not limited to professors, department heads, teaching assistants, secretaries, and/or textbook deputies. Generally, appropriate person(s) refers to the person who is given the responsibility for compiling a booklist and/or distributing it to the local bookstore(s). The appropriate person enters pertinent information into the course material entry utility 211. The pertinent information includes a course's information 213 and course material information 215. The course's information 213 may include but is not limited to the university or college, department, course, section, division, time of day, semester or quarter offered, professor or other contact, contact's email, contact's phone number, and/or number of students enrolled. The course material information 215 includes but is not limited to the title, author, publisher, edition, publication date, if the item is required or recommended and additional comments. The course material information 215 is used to query one or many book databases. The book databases contain pertinent book information which includes but is not limited to the title, author, publisher, edition, publication date and/or ISBN. This allows the person entering the course material information to enter partial information and have the correct and complete information returned from the book database.

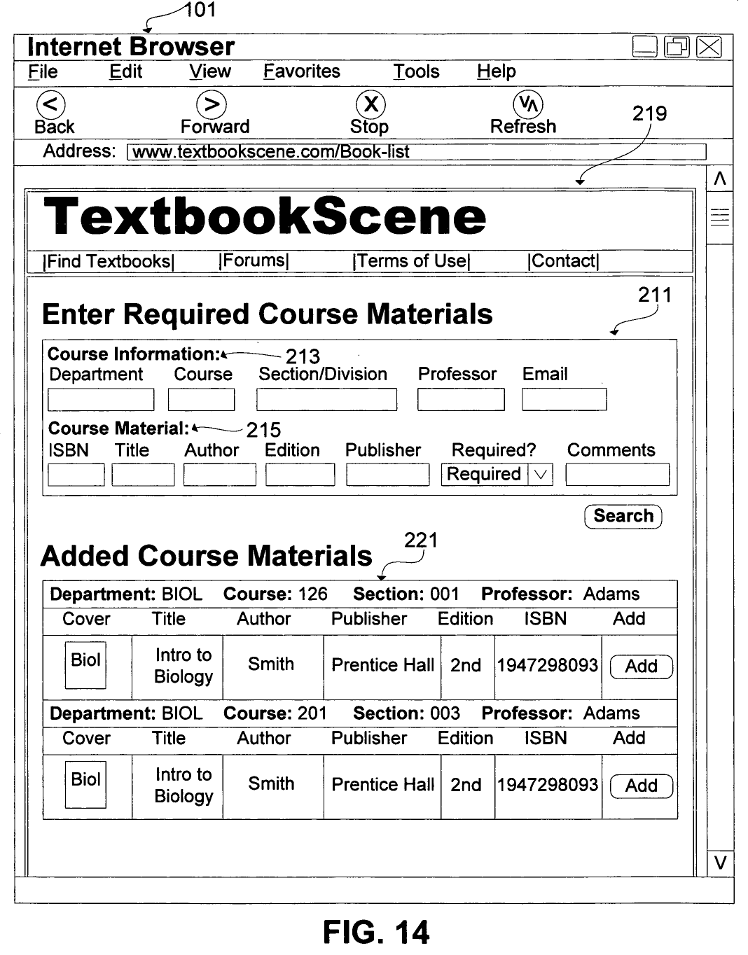

Examples of book databases include those provided by Amazon.com, Books in Print, and the Library of Congress. The books that match the course material information 215 closely or exactly are returned in the search results table 217. The book information displayed 217 includes but is not limited to the title, author, publisher, edition, publication date and ISBN. The appropriate person is then able to select the desired book from the results 217 and add it to the booklist. The book(s) then displayed in the booklist 221 in FIG. 14.

FIG. 14 is a simulated screen of webpage 219 which displays the booklist 221. The appropriate person can review, edit, and/or append the booklist 221.

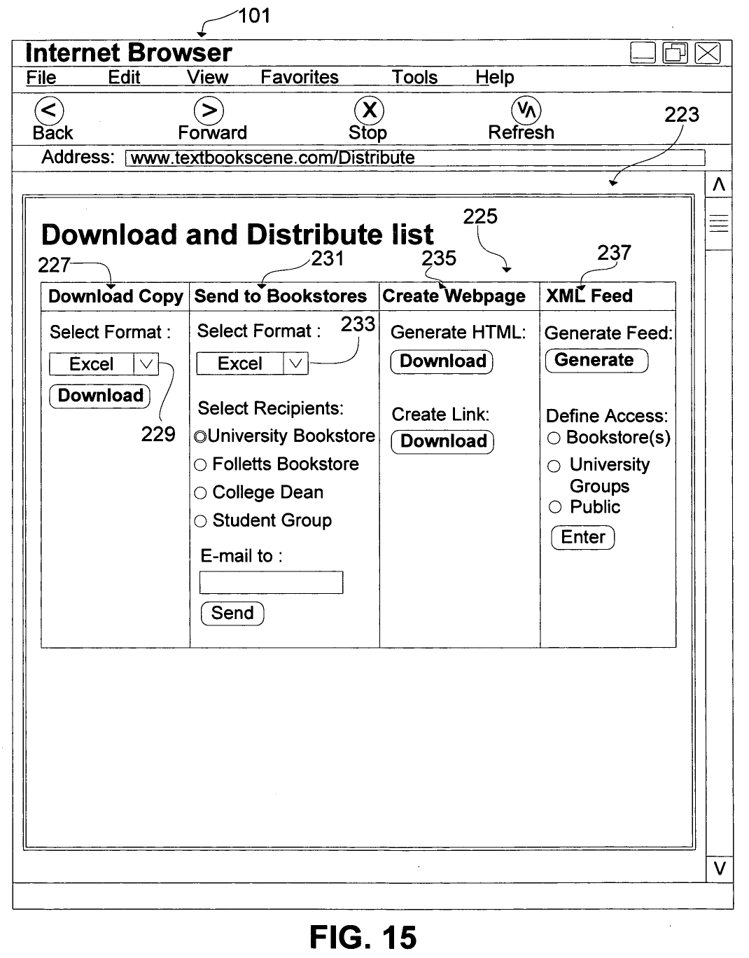

FIG. 15 is a simulated screen of webpage 223 which is a booklist distribution utility 225. The appropriate person has the ability to download the list 227 in various common formats 229, send the booklist to various people 231 in a chosen format 233, create an HTML script of the list or put up webpage displaying the list 235, and/or put up an XML feed of the list 237.

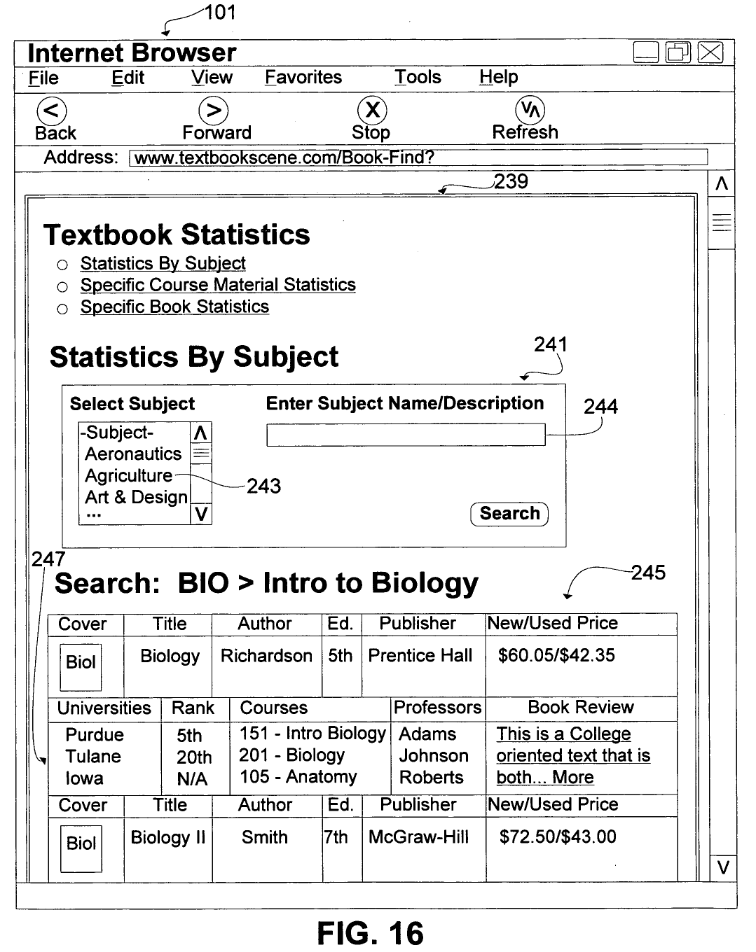

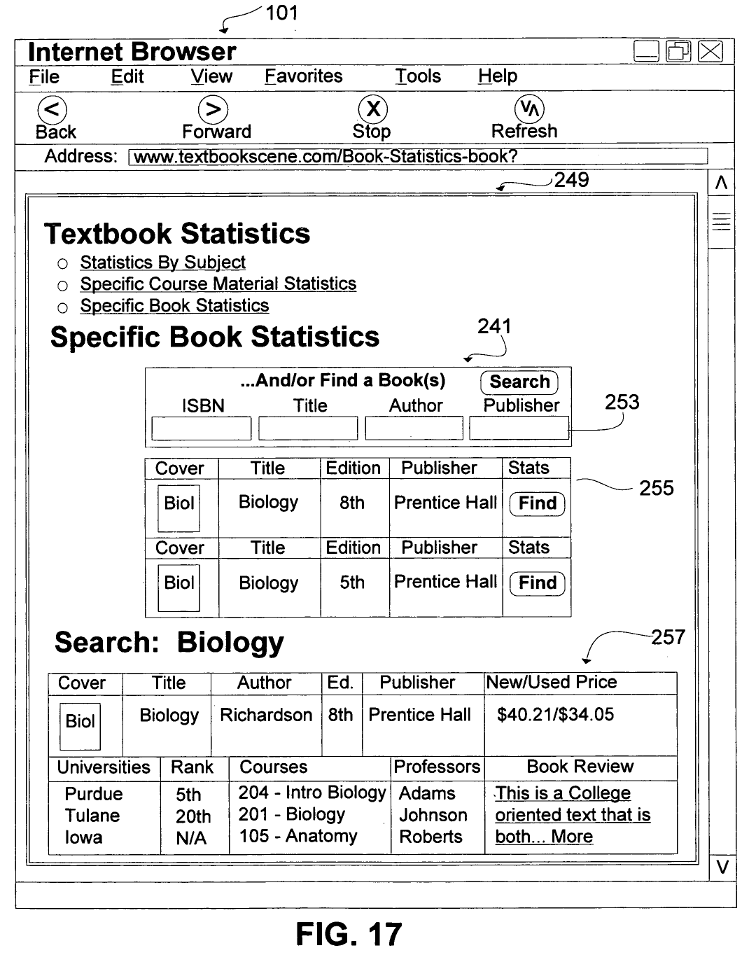

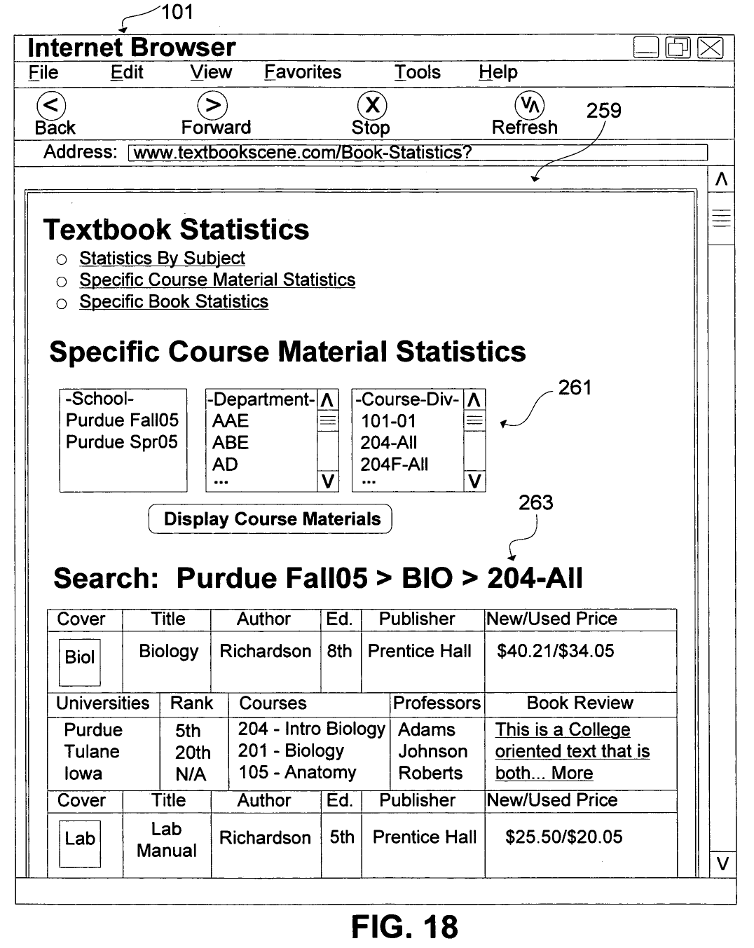

FIG. 16, FIG. 17 and FIG. 18 are a simulated screen of webpage 239, 249 and 259 respectively. These comprise a textbook statistic utility. The textbook statistic utility 241 in FIG. 16 allows the user to select a subject 243, enter a course name and/or description 244. The information provided by the user is cross referenced to one or more of the booklists. The books relating to the query are then displayed 245. The information describing the book(s) displayed includes but is not limited to the title, author, publisher, edition, publication date, ISBN. Furthermore, statistics 247 about the book(s) are displayed. These statistics 247 include but are not limited to, universities/colleges currently using the book, universities/colleges who have previously used the book, the rank of the university/college. the course(s) that the book is being used for, professors who have used the book(s), contact information for the professors, average used book price, average new book price, and a book review. Webpage 249 in FIG. 17 is the part of the textbook statistic utility which allows the user to look up statistics pertaining to a specific book. The user enters information describing the book(s) into the book search field 251. This information includes but is not limited to the title 253, author, publisher, edition, publication date, ISBN. The pertinent book information is used to query one or many book databases as previously described in 030. The user is then selects their chosen book(s) from the book results table 255 and book statistics 257 are displayed. Webpage 259 in FIG. 18 is the part of the textbook statistic utility which allows the user to look up statistics pertaining to a specific course's book(s). The user selects a course using the course select utility 261. The book(s) that are used for the selected course-and the corresponding statistics 263 are displayed.

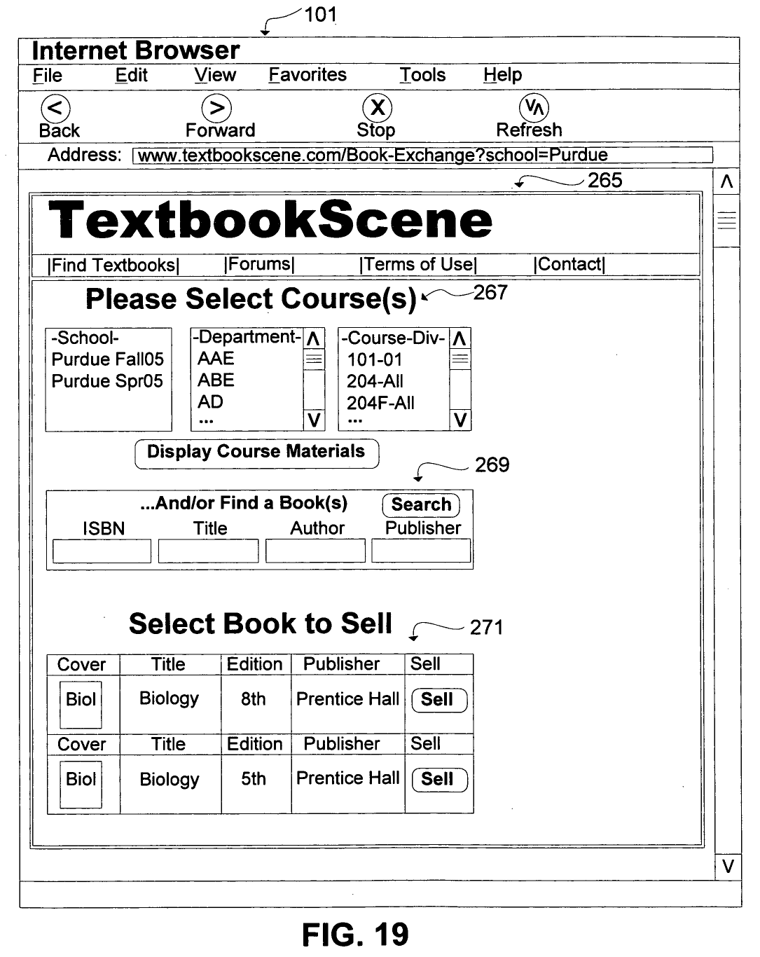

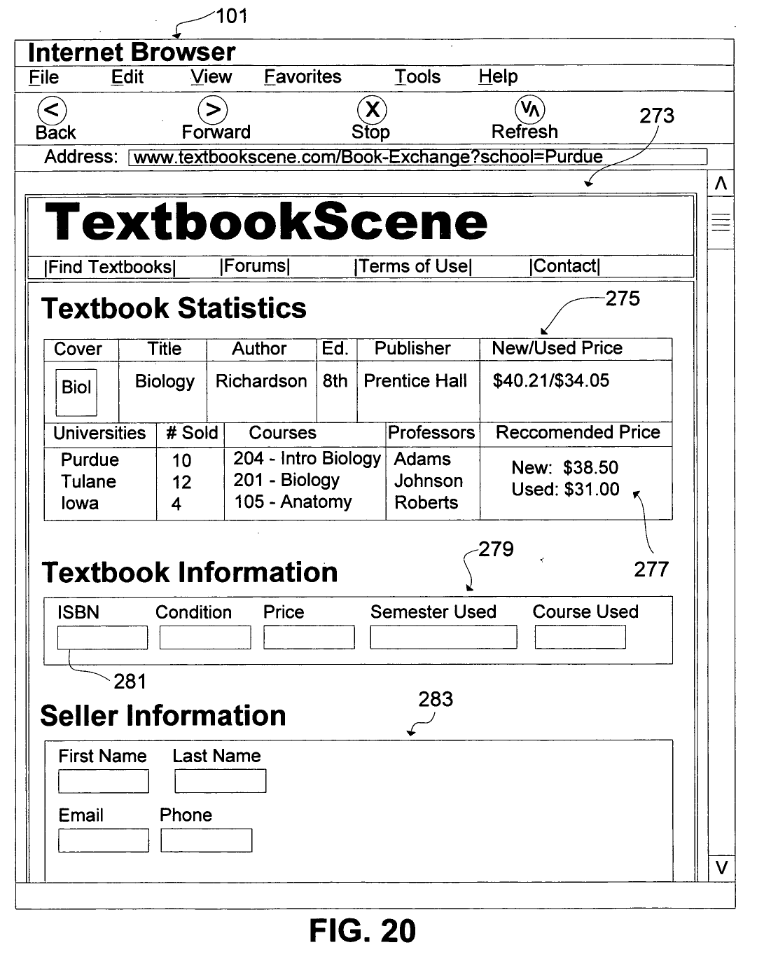

FIG. 19 is a simulated screen of webpage 265 which allows a user to select a book they desire to sell. The user has the option of selecting a course by using the course select utility 267 or by using the book search utility 269. The books associated with the user specified course or query, are then displayed in the book results field 271. The user then selects the desired book(s) that they wish to sell and proceeds to webpage 273 shown in FIG. 20.

FIG. 20 is a simulated screen of webpage 273 which displays book statistics 275 to a user selling a book(s). The user is able to use the statistics about previous book sales, selling price, and number of books sold, to make a more educated decision on how much to ask for the book. The book statistics 275 may include but are not limited to universities/colleges currently using the book, universities/colleges who have previously used the book, the rank of the university/college, the course(s) that the book is being used for, professors who have used the book(s), contact information for the professors, average used book price, average new book price, a book review, number of books sold in the previous semester, number of books sold in the current month, and/or a recommended new and used book price 277. The user then enters information about the book 279. This information may include but is not limited to, ISBN 281, title, author, publisher, edition, publication year, condition, selling price, semester the book was used, and/or the course in which the book was used.

Information about the book that is provided by the user, such as the ISBN 281, can be cross referenced to the current book lists. This verifies that the book that is being sold is in fact being used by the course the user specified. Finally, the user enters their information in the seller information field 283. The seller information can include, but is not limited to, first name, last name, user name, phone number, email, credit card number, credit card expiration date, a password, and the user's address. The book that the user has posted can subsequently be displayed in other user's book search results. The book can then be purchased from the user who posted it, the seller. The book will then be shipped by the seller to the user who purchases the book. A fee of some sort may or may not be charged to the seller for posting the book and/or selling the book.

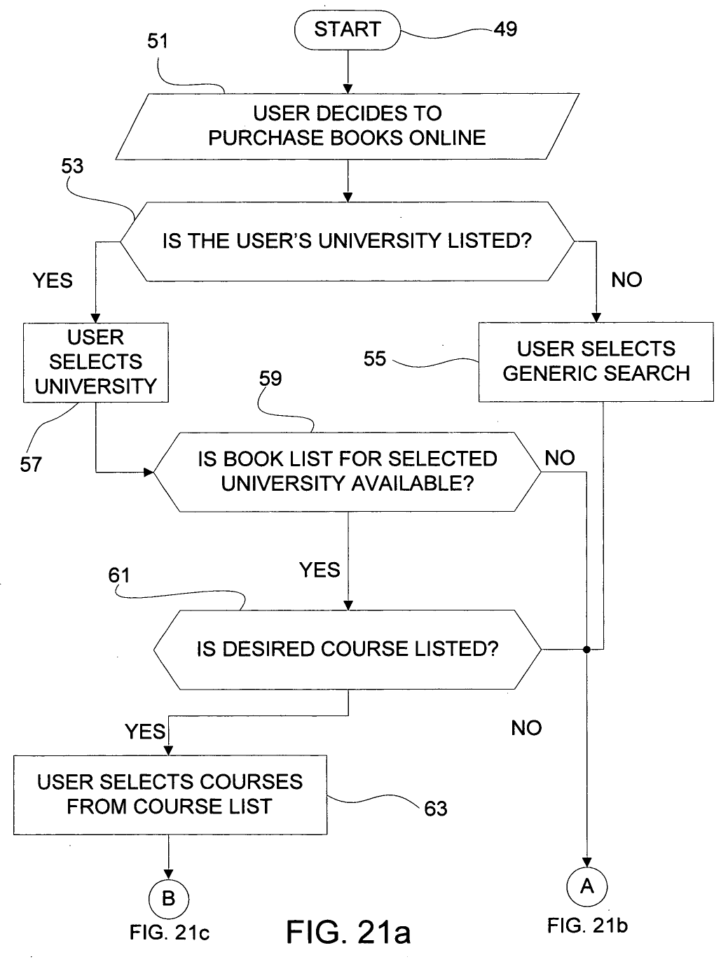

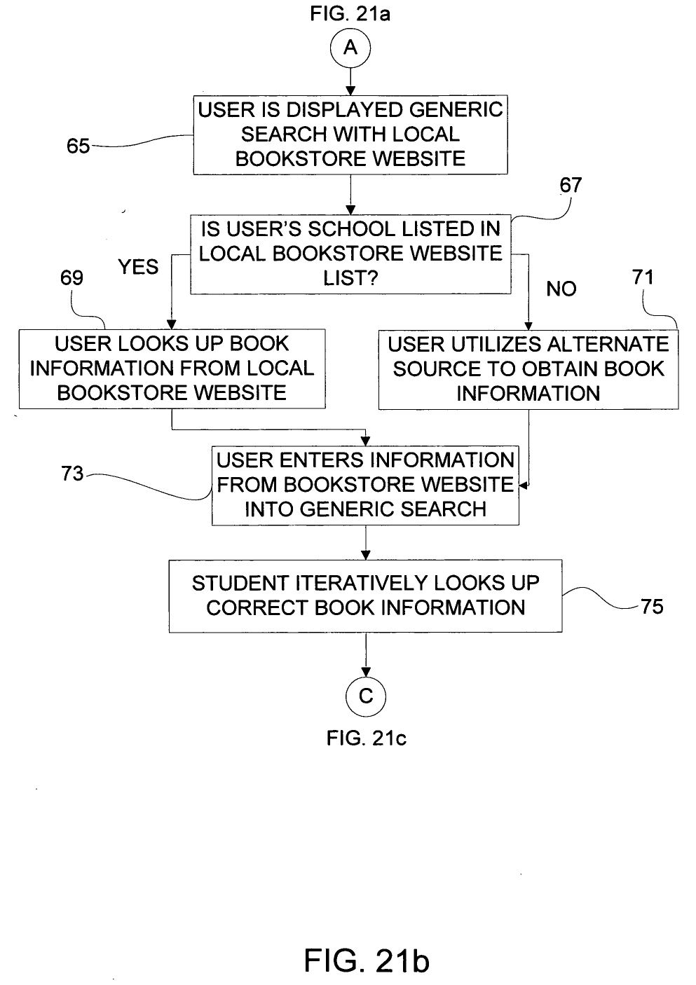

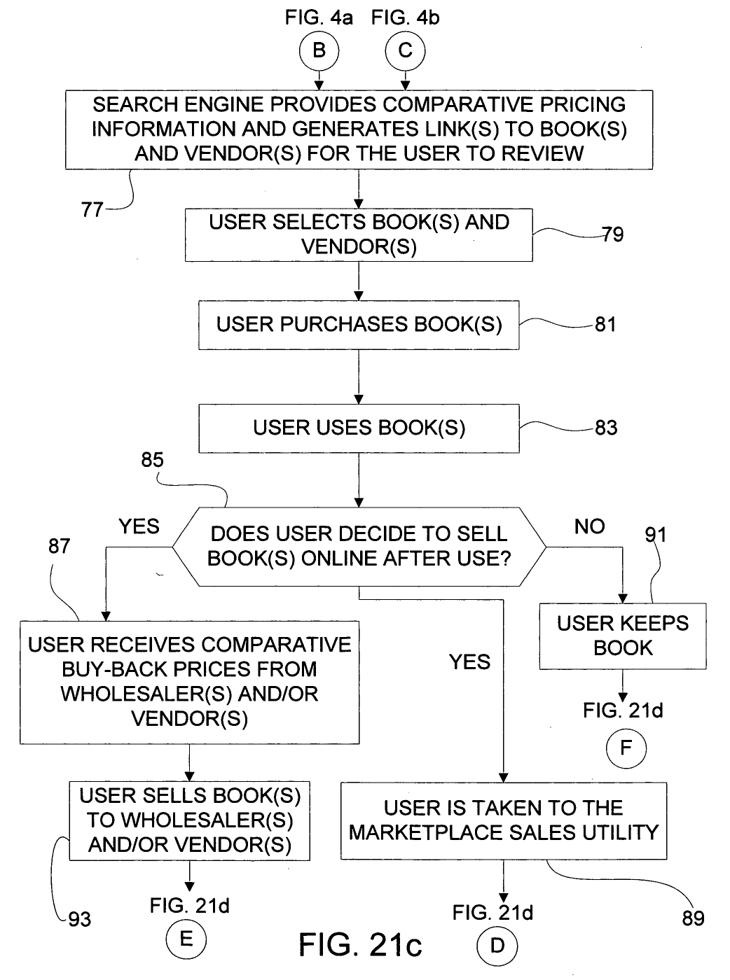

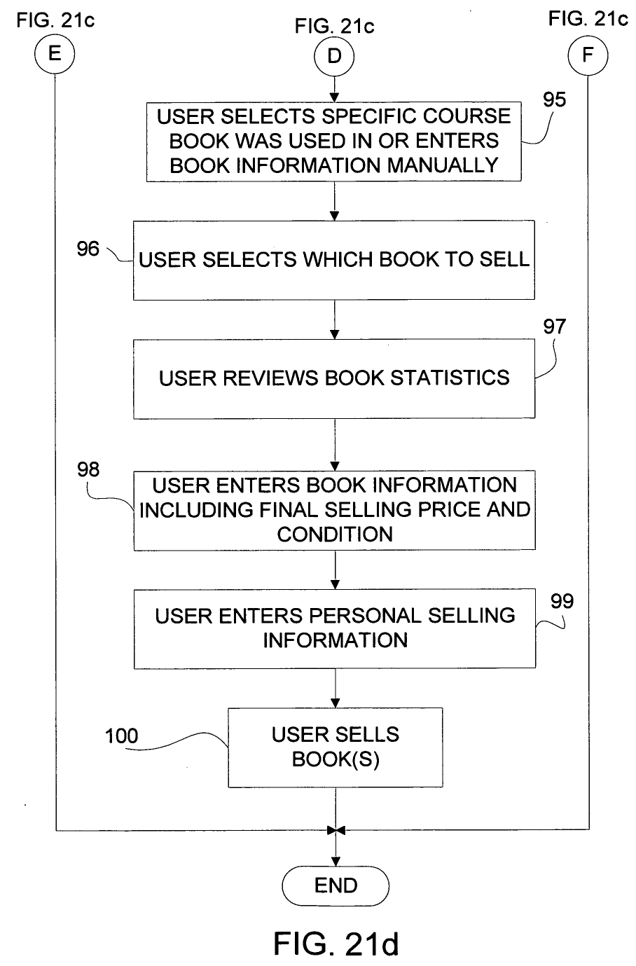

FIGS. 21a -d arranged vertically illustrate a flowchart of one possible implementation of an improved search engine which utilizes all of the novel methods previously described. Once a user decides to purchase their books online 51, they will decide if their college or university is listed 53. If the university is listed, the user selects their university 57. If the university is not listed 55 the user is directed to the generic book search utility. If the booklist is available for the university selected 59, the user can proceed to find the course they are taking 61. If the course is not listed in the course list or the booklist for the university is not available the student is displayed the local bookstore's website with a generic book search utility 65. The student looks for the book information on the bookstore's website 67. If the book information is available, the user looks up the pertinent book information 69. If it is not available the student the student has to find the information through alternate means 71. The student then enters the gathered information into the book search utility 73 and iteratively searches until desired book is found 75.

If the student's course was listed or if the student found their book information using the book search utility, the search engine returns comparative pricing for the selected books from multiple vendors 77. The student then selects the books they wish to purchase 79 and they buy them through a vendor of their choice 81. The student then uses the book 83. If the student decides to sell the book online 85 they can get comparative buy-back pricing from wholesalers 87 or they can list the book using the marketplace utility 89. The student can then sell their book to the wholesaler 93, or list their book for sale using the market place utility. The user first must specify the course in which the book was used 95. The user then indicates which book they are seller from the list of books used for the course 96. The user reviews statistics about the book, it's pricing and current demand 97. The user enters information about the book, it's condition, and the asking price 98. The user then enters their personal information 99. The user sells the book 100.

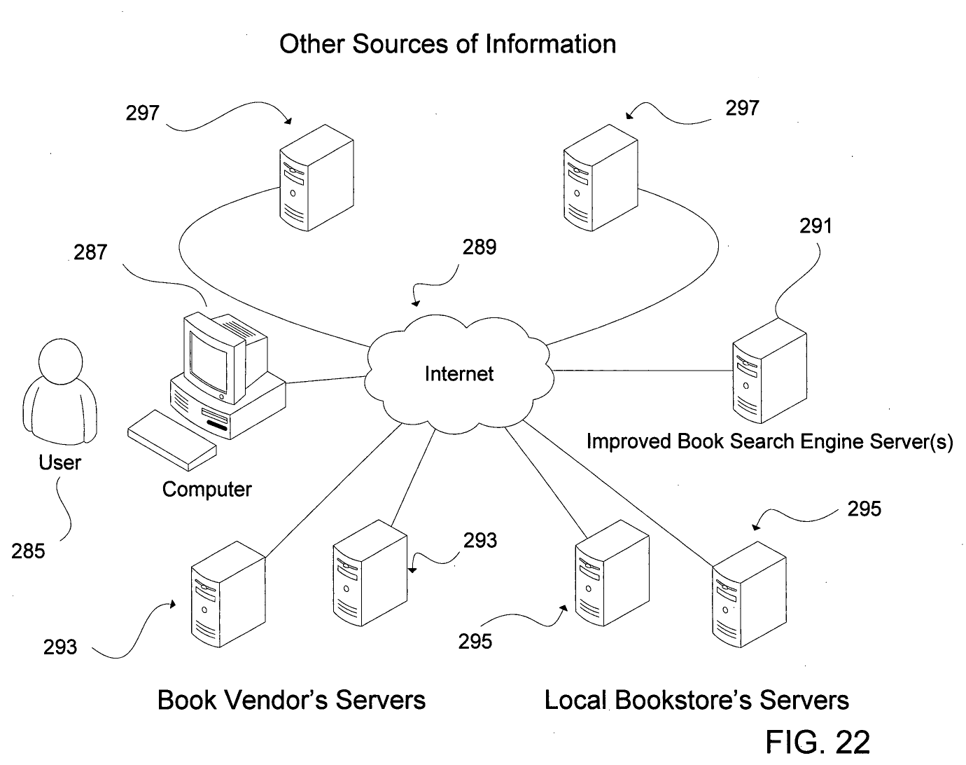

FIG. 22 is a network diagram of the system on which the previously described improved search engine operates. The user 285 uses a computer 287 to connect to the internet 289. The computer 287 is a device that allows the user to connect to the internet and includes but is not limited to a personal computer, desktop computer, laptop, cell phone, PDA, or computer terminal. The user is then able to access the improved book search engine server(s) 291. The improved book search engine server stores the booklist database, user information, and textbook market information. When the user 285 desires to use one of the services of the improved book search engine's website, the information that is pertinent to the user's request is retrieved from the appropriate sources via the internet 289. For clarity, the sources of information have been put into three groups. These include but are not limited to book vendor's server(s) 293, the local bookstore's server(s) 295, and other sources of information 297. Once the pertinent information is retrieved the information is processed by the improved book search engines server 291 and displayed to the user 285. The content that is displayed to the user 285 may have hyperlinks that reference further information that is available on servers other than the improved book search engine server 291.

What is claimed is:

1. A method for obtaining comparative pricing of textbooks from input course information which comprises:
a. Entering course information into a computer,
b. Using the entered course information to compare with stored correlation information to generate a set of information corresponding to the textbooks for the entered course information,
c. Using the set of information to automatically search for pricing information from two different pricing sources, and
d. Simultaneously displaying for comparison the pricing information from each of the two different pricing sources.

2. The method of claim 1 in which each of said two different pricing sources are different internet websites, and which additionally includes the step of making a textbook purchase through said website.

3. The method of claim 1 in which said entering includes the entering of course information from more than one course.

4. The method of claim 3 which additionally includes the step of giving the user the option of either purchasing from one source or from two sources.

5. The method of claim 4 in which the option of selecting either the lowest price using two different sources or the lowest price from a single source is provided.

6. The method of claim 5 in which the entered course information is used to automatically generate price comparisons from two different internet websites displayed in two different frames by the same computer used for inputting the course information.

7. The method of claim 6 which additionally includes the step of printing a booklist corresponding to the courses entered into the computer.

8. A web based method for providing comparative pricing of textbooks from course information input to a web server over the internet which comprises:
a. Providing to a user via an internet website a display containing a first frame and a second frame,
b. Providing information from another website that provides information correlating course information with textbook information to be displayed in said first frame, and
c. Providing information from another website that provides in the second frame, information about pricing of the textbooks in identified in the first frame,
d. Whereby the user can view on a single display from a remote website, two frames each from different websites, thereby facilitating the entry of course information to determine the related textbook pricing.

9. The method of claim 8 which additionally includes the step of automatically transferring the textbook information from the first frame to the second frame, whereby the pricing query can occur without textual data entry or clipboard use by the user.

10. An internet based method for purchasing textbooks for courses which comprises:
a. logging on to a first website that provides course textbook correlation information,
b. entering course information to generate from the website an electronic data set of textbooks corresponding to the course information entered,
c. using the electronic data set to automatically query a second website via the internet for pricing information for the set of textbooks, and
d. purchasing textbooks from the second website.

11. The method of claim 10 in which the step of using additionally includes the step of automatically cross referencing with a plurality of bookstores to determine the one best meeting specified criteria for the set among the plurality of bookstores.

12. The method of claim 11 in which the specified criteria is having the lowest price.

13. A method of providing textbook statistics which comprises:
a. Compiling a database that includes textbook information from many textbooks from several different publishers,
b. Associating with each of said many textbooks the identity of the universities using that textbook, and other course information relating to that textbook's use at such university, and
c. Providing web access to statistical information from this associated data to others over the internet.

14. The method of claim 13 which additionally includes the step of associating with each textbook, the rank of such university, or the rank of the department within such university to which the course information relates and providing that ranking information along with the statistical information.

15. The method of claim 14 in which said associating includes as to each textbook, the names of each professor using that textbook.

16. The method of claim 15 which additionally includes either an email address or a phone number associated with at least several of the professors whereby contact can be readily attempted to learn of their opinion of the textbook.

17. A method for creating a web-based association of courses with textbooks comprising:
a. Providing a web server that has a database that can be accessed by web users to enter data associating course information with textbook information,
b. Processing such information received to take into account the identity of the provider of such information,
c. Making such information available to others via the web in a manner that reflects the reputation of the supplier of information.

18. The method of claim 17 in which the reputation criteria includes comparison of the accuracy of other information provided by a provider when the accuracy of the other information is known.

19. A web-based method that aids in determining the value of used textbooks which comprises:
a. accessing via the internet a web server that provides access to a database that includes course information and correlated textbook information;
b. automatically using that textbook information to query other data reflecting textbook pricing; and
c. displaying such course and pricing information in response to a query inputting either textbook information or course information, whereby the use of a clipboard or text entry to transfer information from the textbook data to query the textbook pricing data is not needed.

20. The method of claim 19 in which said displaying is in response to inputting course information.

21. The method of claim 19 in which said automatically using that textbook information queries a remote database.

22. The method of claim 19 in which said automatically using that textbook information queries a local database that is generated from prior transactions of other users.

23. The method of claim 22 which additionally supplies to the user information as to the ranges of prices that prior users have paid.

24. The method of claim 23 which additionally supplies to the user information as to the condition of the books.

25. The method of claim 22 which additionally supplies information as to the number of sales.

26. The method of claim 25 in which the additionally supplying is provided in groups according to the condition of the books.
